(19) United States
(12) Patent Application Publication
(10) Pub. No.: US 2001/0039140 A1
(43) Pub. Date: Nov. 8, 2001

(54) Electrical connector assembly with light transmission module

(76) Inventors: Michael Fasold, Leutenbach (DE); Heinrich Fuchslocher, Mannehim (DE); Otto Schemp, Bad Rappenau (DE)

Correspondence Address: A. A. Tirva, MOLEX INCORPORATED, 2222 Wellington Court, Lisle, IL, 60532, US

(21) Appl. No.: 09/817,883

(22) Filed: Mar. 26, 2001

(30) Foreign Application Priority Data
Apr. 5, 2000 (EP) 00 107 351.9

(51) Int. Cl. H01R 3/00

(52) U.S. Cl. 439/490

(57) ABSTRACT

A connector assembly is disclosed for electrically connecting at least one mating plug to a circuit board. The assembly includes a connector housing adapted for mounting on the circuit board and having a front face with at least one receptacle for receiving the mating plug. An independent light module includes a module housing adapted for mounting to one side of the connector housing. A plurality of terminals are mounted on the module housing and include connecting portions for connection to the circuit board. At least one light emitting device is connected to a portion of at least one terminal remote from the connecting portion thereof for emitting light generally at the front face of the connector housing.

### FIELD OF THE INVENTION

This invention generally relates to the art of electrical connectors and, particularly, to an electrical connector which has a light transmission module for visual indication.

### BACKGROUND OF THE INVENTION

Electrical connections having built-in indicator lights have been known for some time. In these connectors, the indicator lights typically are located at the front of the connector. A typical connector may include an integral LED device to emit a light which indicates an operational function such as the reception or transmission of data or voice signals, verification of a good connection between separate pieces of equipment, indication when power is on or off, indication of a defect in a network transmission or any other state or condition in the equipment with which the connector is operatively associated.

Visual light indicating connectors are popular in modular jacks or similar types of connectors commonly used in telecommunications and data networking equipment. These jacks often are mounted on a circuit board to which they are to be connected. Problems have been encountered in incorporating such light indicating devices, such as LED devices, directly onto the connector due to the ever-increasing miniaturization and density of telecommunications and data networking equipment.

In particular, one problem involves interference with the signal or data transmission functions of connectors caused by the incorporation of visual light indicating means. Quite often, the LED's are located in proximity to the connector housing and the signal carrying terminals within the housing. The switching on and off of the LED's generates electrical interference (EMI) which creates noise or “crosstalk” on the signal terminals or the signals transmitted through the terminals.

Some prior art devices work satisfactorily to provide visual indication. However, LED's are mounted at the front of the housing which requires running the LED leads all the way across the housing and then down the back of the housing to establish electrical connection with circuits on the circuit board. This type of lead routing may cause EMI or other problems which effect signal transmission quality. In order to solve these problems, LED's have been mounted at the rear of the housing or on the circuit board with the connector mounted over the LED's, and light pipes then are used to transmit the light emitted by the LED's to the front face of the connector housing. While the latter system might alleviate some of the EMI, there still is interference because of the close proximity of the LED's to the circuit board connector interfacing. The present invention is directed to solving these various problems by a unique modular concept which includes an independent light module mounted on the connector housing.

### SUMMARY OF THE INVENTION

An object, therefore, of the invention is to provide a new and improved electrical connector assembly having a light transmission module for visual indication.

In the exemplary embodiment of the invention, the connector assembly is provided for electrically connecting at least one mating plug to a circuit board, although the invention is not limited to this particular disclosed application. The assembly includes a connector housing adapted for mounting on the circuit board. The housing has a front face with at least one receptacle for receiving the mating plug. An independent light module includes a module housing adapted for mounting to one side of the connector housing. A plurality of terminals are mounted on the module housing and include connecting portions for connection to the circuit board. At least one light emitting device (LED) is connected to a portion of at least one terminal remote from the connecting portion thereof for emitting light generally at the front face of the connector housing.

As disclosed herein, the at least one terminal is stamped and formed of conductive sheet metal material. The LED is surface mounted to the stamped terminal, as by soldering. The housing is fabricated of plastic material and is overmolded about portions of the terminals.

According to one aspect of the invention, the light module includes a cover over the LED. In one embodiment, the cover has an opening adjacent the front face of the connector housing for passing light therethrough from the LED. In another embodiment of the invention, a light pipe is provide over the LED, and the cover is disposed over the light pipe except for a portion thereof adjacent the front face of the connector housing.

Another feature of the invention may include a metal shield disposed between the connector housing and the module housing. In the preferred embodiment, the connector housing includes a generally planar side wall, and the shield is provided by a shielding plate juxtaposed against the planar side wall.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a front perspective view of a connector assembly incorporating the independent light module of the invention;

FIG. 2 is an exploded front perspective view showing the light module separated from the connector;

FIGS. 3-6 are perspective views showing the steps in fabricating the light module;

FIGS. 7-11 are perspective views showing the steps in fabricating an alternate embodiment of the light module;

FIG. 12 is a front perspective view similar to that of FIG. 1, but of an embodiment incorporating a shield between the connector housing and the module housing;

FIG. 13 is an exploded perspective view of the shielded embodiment of FIG. 12; and

FIG. 14 is a front perspective view similar to that of FIG. 1, but showing an embodiment in which the connector has a pair of receptacles for receiving a pair of mating plugs.

### DETAILED DESCRIPTION OF THE PREFERRED EMBODIMENTS

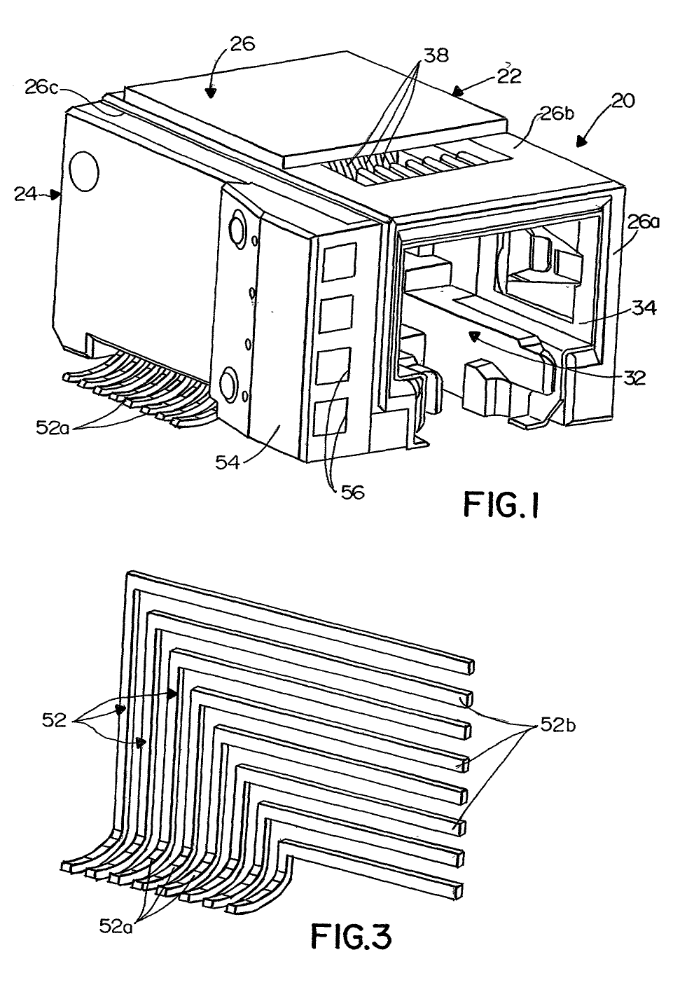

Referring to the drawings in greater detail, and first to FIG. 1, the invention is embodied in a connector assembly, generally designated 20, for electrically connecting at least one mating plug to a printed circuit board (not shown). The assembly includes an electrical connector, generally designated 22, in the form of a modular jack, and an independent light module, generally designated 24, mounted to one side of the modular jack.

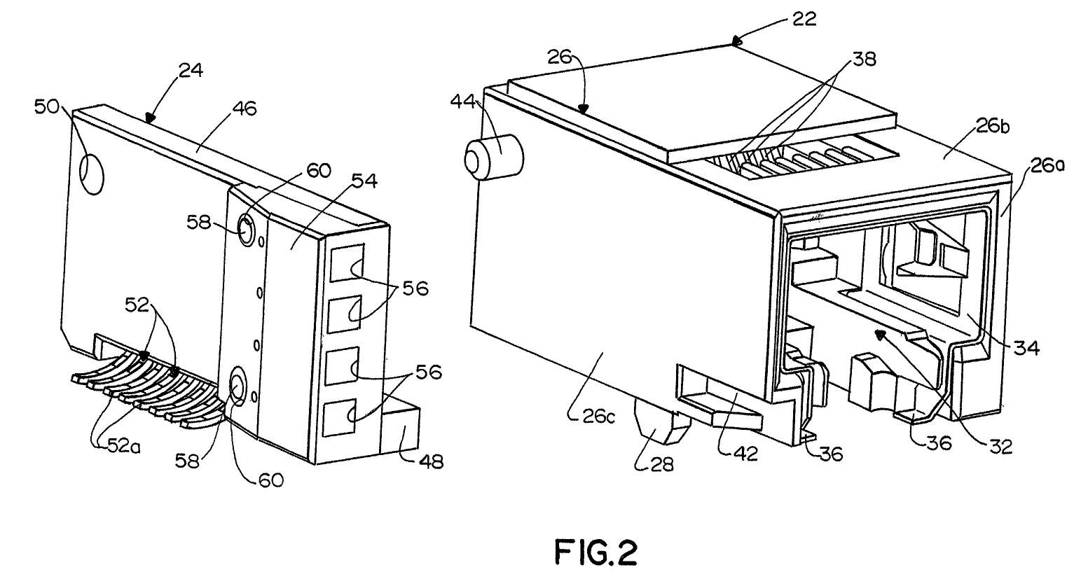

FIG. 2 shows light module 24 removed from modular jack or connector 22. The modular jack includes a one-piece integrally molded plastic housing, generally designed 26, having one or more integral mounting posts 28 for mounting the housing and jack on the circuit board. The housing defines a front face 26a having a receptacle, generally designated 32, for receiving a mating plug (not shown). The housing has a top side 26b and a lateral side 26c. An interior shield 34 is mounted within the front part of receptacle 32 for engaging an appropriate exterior shield on the mating plug. Shield 34 has a pair of feet 36 for connection, as by soldering, to ground traces on the circuit board. Modular jack 22 is fairly conventional and, suffice it to say, includes a plurality of terminals 38 mounted therein and extending into receptacle 32 for engaging appropriate complementary terminals on the mating plug. Terminals 38 have tail portions (not visible in the drawings) for connection, as by soldering, to appropriate circuit traces on the printed circuit board. Lateral side 26c of housing 26 includes an elongated recess 42, and a mounting post 44 projects from the side diagonally from the recess.

Light module 24 includes a molded plastic module housing 46 having an elongated mounting rib 48 and a mounting hole 50. When the light module is mounted to the modular jack, rib 48 is disposed in recess 42 and mounting hole 50 receives mounting post 44, as by a press-fit. A plurality of terminals, generally designated 52, are mounted on module housing 56 and include tail portions 52a for connection, as by soldering, to appropriate circuit traces on the circuit board. An opaque cover 54 is mounted on module housing 46 and has a plurality of light-emitting windows 56 at the front thereof. The cover is mounted on module housing 46 by means of a pair of mounting posts 58 projecting from the housing and press-fit into a pair of mounting holes 60 in the cover.

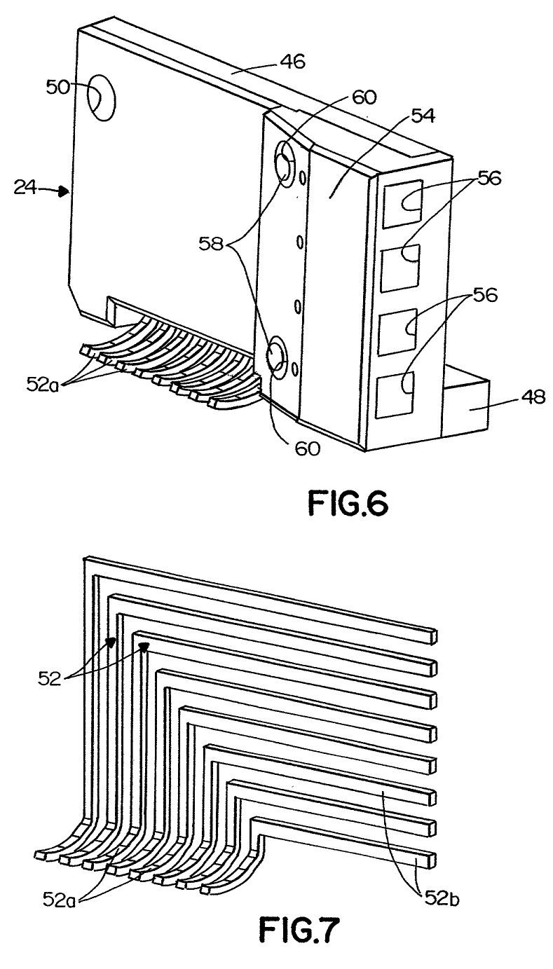

FIGS. 3-6 show the steps in fabricating light module 24 (FIG. 6). First, terminals 52 are stamped from conductive sheet metal material in nested right-angled configurations and formed with tail portions 52a. Planar contact arm portions 52b are stamped at ends of the terminals opposite tails portions 52a.

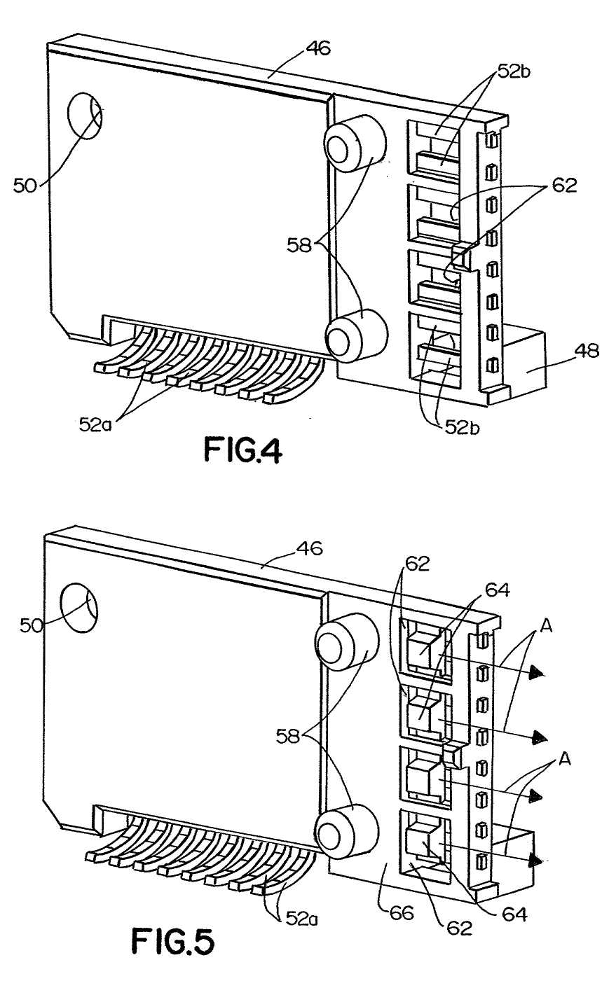

The next step is shown in FIG. 4 wherein plastic module housing 46 is overmolded about terminals 52, leaving tail portions 52a exposed at the bottom of the housing, and leaving planar contact arm portions 52b exposed within openings 62 along the front edge of the housing. It can be seen that the housing has been molded with rib 48 and hole 50 for mounting the light module to the connector and with posts 58 for mounting cover 54 to the light module.

FIG. 5 shows the next step in fabricating the light module and includes connecting a plurality of light emitting devices (LED's) 64 to respective pairs of planar contact arm portions 52b (FIG. 4) within openings 62 in the module housing. The LED's may be surface soldered to the planar contact arm portions of the terminals. It can be seen in FIG. 5 that LED's 64 are sufficiently large to project outwardly of a flat face 66 of module housing 46, so that the LED's are capable of transmitting light at least in the direction of arrows “A”, i.e., forwardly of the connector assembly.

FIG. 6 shows the final step in fabricating light module 24, and includes mounting cover 54 onto module housing 46. After the cover is mounted, LED's 64 can transmit light through light emitting windows 56 at the front of the cover, again as indicated by arrows “A” in FIG. 5. It can be seen that when light module 24 is mounted to modular jack or connector 22, LED's 64 are considerably removed from the connecting interface of the jack terminals, particularly with the circuit board.

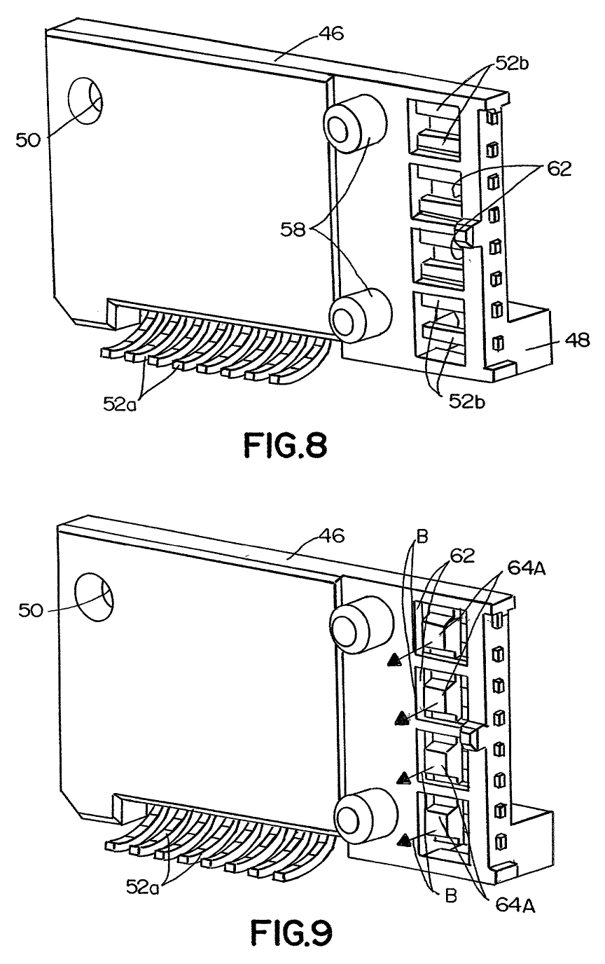

FIGS. 7-11 show the steps in fabricating an alternate embodiment of light module 24 and like numerals have been applied in these figures corresponding to like components described above in relation to FIGS. 3-6. In fact, the first steps of stamping and forming terminals 52 in FIG. 7 and overmolding module housing 46 about the terminals as shown in FIG. 8 is identical to the steps and descriptions above in relation to FIGS. 3 and 4, and will not be repeated.

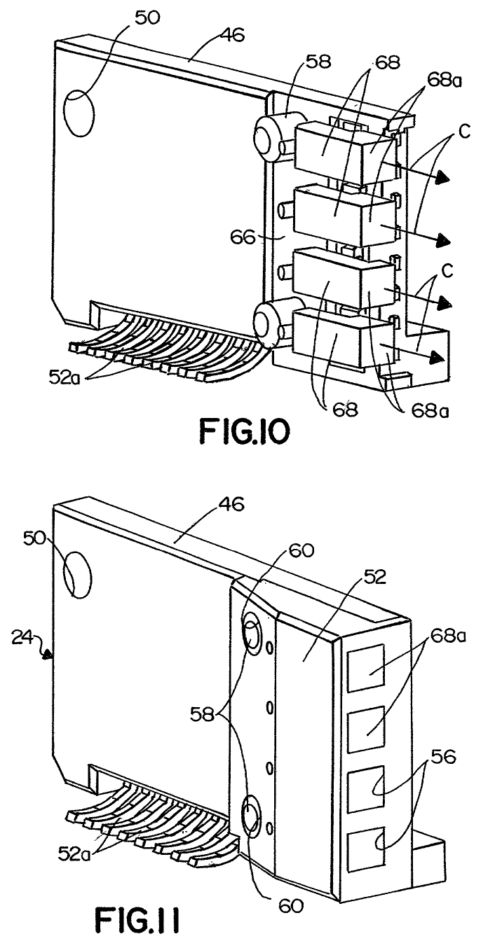

In comparing FIG. 9 with FIG. 5, it can be seen that LED's 64A in FIG. 9 are smaller than LED's 64 in FIG. 5. LED's 64A will emit light primarily in the direction of arrows “B” (FIG. 9).

FIG. 10 shows that in the alternative embodiment, a plurality of light pipes 68 are adhered to face 66 substantially covering LED's 64A and openings 62 within which the LED's are disposed. Light pipes 68 have front faces 68a through which light from the LED's is directed in the direction of arrows “C”.

FIG. 11 shows cover 54 mounted on module housing 46, with the front faces 68a of light pipes 68 exposed through light emitting windows 56 at the front of the cover. Therefore, except for the reduction in size of LED's 64A and the addition of light pipes 68, the light module shown fabricated in FIGS. 7-11 is the same as the light module shown fabricated in FIGS. 3-6.

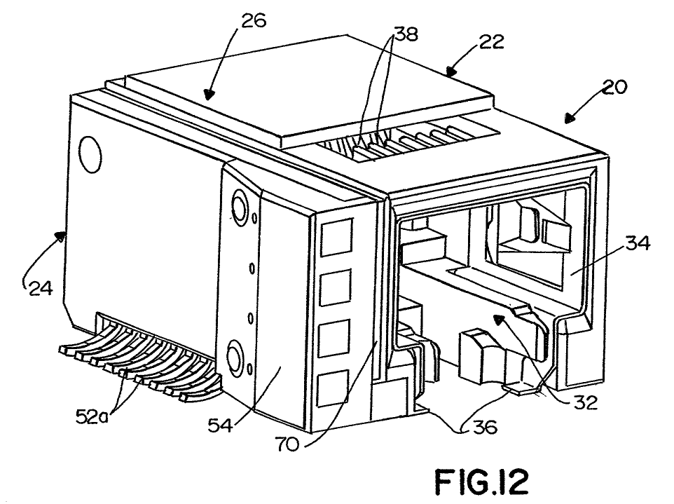

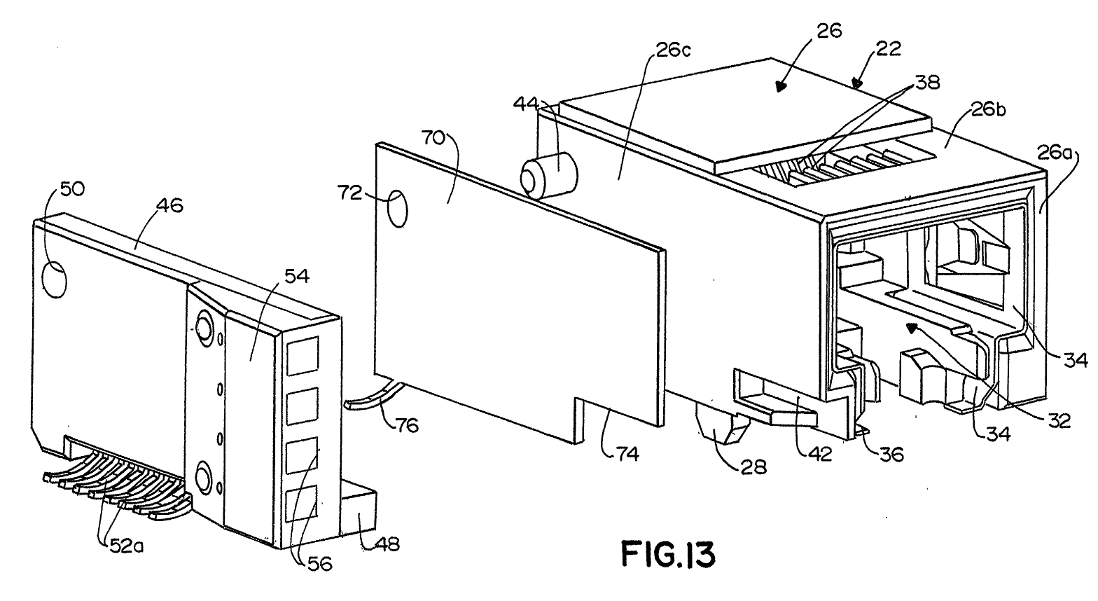

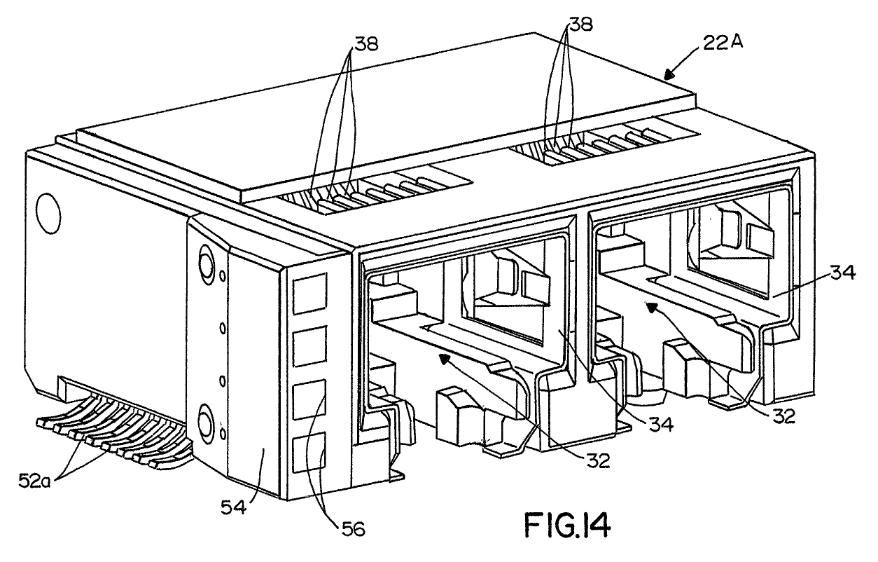

FIGS. 12 and 13 show another embodiment of the invention which incorporates a shield 70 disposed between connector housing 26 and module housing 46. The shield is in the form of a conductive shielding plate juxtaposed against planar lateral side 26c of connector housing 26. The shielding plate has a hole 72 for accommodating mounting post 44 from the connector housing and a cutout 74 for accommodating rib 48 from the module housing. Therefore, when the light module is mounted to the modular jack or connector as shown in FIG. 12, shielding plate 70 is tightly sandwiched therebetween. As seen in FIG. 13, the shielding plate has an integral tail portion 76 for connection, as by soldering, to a grounding pad on the circuit board.

FIG. 14 shows a further embodiment of the invention wherein light module 24 is mounted at one side of a modular jack or connector 22A which is a multi-port connector. In other words, the connector includes a pair of side-by-side receptacles 32 for receiving a pair of mating plugs. Each receptacle has its own set of terminals 38 and its own interior shield 34. Otherwise, connector 22A and light module 24 are operatively associated and interengaged as described above in relation to FIGS. 1-13.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

We claim:

1. A connector assembly for electrically connecting at least one mating plug to a circuit board, comprising:
a housing adapted for mounting on the circuit board and having a front face with at least one receptacle for receiving the mating plug; and
an independent light module including
a module housing adapted for mounting to one side of the connector housing,
a plurality of terminals mounted on the module housing and including connecting portions for connection to the circuit board, and
at least one light emitting device (LED) connected to a portion of at least one terminal remote from the connecting portion thereof for emitting light generally at the front face of the connector housing.

2. The connector assembly of claim 1 wherein said at least one terminal is a stamped and formed metal terminal.

3. The connector assembly of claim 2 where said LED is surface mounted to said at least one stamped terminal.

4. The connector assembly of claim 3 wherein said LED is surface soldered to said at least one stamped terminal.

5. The connector assembly of 1 wherein said light module includes a cover over the LED except for an opening in the cover adjacent the front face of the connector housing.

6. The connector assembly of claim 1 wherein said light module includes a light pipe over the LED.

7. The connector assembly of claim 6 wherein said light module includes a cover over the light pipe except for a portion thereof adjacent the front face of the connector housing.

8. The connector assembly of claim 1 wherein said module housing is of plastic material and is overmolded about portions of said terminals.

9. The connector assembly of claim 1, including a metal shield between the connector housing and the module housing.

10. The connector assembly of claim 9 wherein said one side of the connector housing comprises a generally planar wall, and said shield comprises a shielding plate juxtaposed against the planar wall.

11. A connector assembly, comprising:
a connector housing having a front face; and
an independent light module including
a plurality of terminals,
a module housing overmolded about portions of the terminals and adapted for mounting to the connector housing, and
at least one light emitting device (LED) connected to an exposed portion of at least one of the overmolded terminals for emitting light generally at the front face of the connector housing.

12. The connector assembly of claim 11 wherein said at least one terminal is a stamped and formed metal terminal.

13. The connector assembly of claim 12 where said LED is surface mounted to said at least one stamped terminal.

14. The connector assembly of claim 13 wherein said LED is surface soldered to said at least one stamped terminal.

15. The connector assembly of 11 wherein said light module includes a cover over the LED except for an opening in the cover adjacent the front face of the connector housing.

16. The connector assembly of claim 11 wherein said light module includes a light pipe over the LED.

17. The connector assembly of claim 16 wherein said light module includes a cover over the light pipe except for a portion thereof adjacent the front face of the connector housing.

18. The connector assembly of claim 11, including a metal shield between the connector housing and the module housing.

19. The connector assembly of claim 18 wherein said one side of the connector housing comprises a generally planar wall, and said shield comprises a shielding plate juxtaposed against the planar wall.
